(19) United States
(12) Patent Application Publication
(10) Pub. No.: US 2018/0368320 A1
(43) Pub. Date: Dec. 27, 2018

(54) Draper Head with Multipart Screw Conveyor

(71) Applicant: Carl Geringhoff GmbH & Co. KG, Ahlen (DE)

(72) Inventors: Stephan Schulze Selting, Ennigerloh (DE); Steffen Sudhues, Ahlen (DE); Jan Schulze Rückamp, Ennigerloh (DE); Christoph Hartmann, Hamm (DE); Dirk Webermann, Senden (DE); Martin Brinkmann, Altenberge (DE)

(21) Appl. No.: 16/013,991

(22) Filed: Jun. 21, 2018

(30) Foreign Application Priority Data
Jun. 21, 2017 (DE) 10 2017 113 775.0

(51) Int. Cl. A01D 41/14; A01D 69/00; A01D 57/20; A01D 34/835

(52) U.S. Cl. CPC A01D 41/142; A01D 34/8355; A01D 57/20; A01D 69/00

(57) ABSTRACT

A cutting system for a combine harvester has a three-part frame with frame parts articulately joined with each other. A cutter bar, a reel, a central belt conveyor system, and lateral belt conveyor systems for discharging the cut stalk material are supported by the frame. The lateral belt conveyor systems move transversely to the travel direction towards the central belt conveyor system. The central belt conveyor system moves contrary to the travel direction. To prevent accumulation of crop material near the rear wall of the lateral belt conveyor systems, a three-part screw conveyor is arranged near the rear wall and extends across the operating width of the cutting system such that the length of the screw conveyor parts corresponds at least approximately to the width of the frame parts. The screw conveyor parts are powered by a joint drive. Adjacent screw conveyor parts are mutually connected by universal joints.

### BACKGROUND OF THE INVENTION

The present invention relates to a cutting system for being attached to a combine harvester with a three-part frame, the frame parts of which are articulately joined with each other, a cutter bar, a reel, a central belt conveyor system as well as lateral belt conveyor systems for disposing of the cut stalk material that are supported on the frame, such that the lateral belt conveyor systems convey transversely to the direction of travel in the direction of the central belt conveyor system, and the central belt conveyor system conveys contrary to the direction of travel, a multi-part rear wall of the cutting system embodied on the frame parts, which extends along the conveyor line of the lateral belt conveyor system and which features a discharge opening for discharging the harvested crop to the combine harvester in the area of the central belt conveyor system, and drive units in order to drive the cutter bar and the belt conveyor systems.

In DE 10 2014 009 159 A1, the art of constructing a generic draper cutting system in three parts is disclosed, with a central frame and two lateral frames, the latter being movable relative to the central frame.

From U.S. Pat. No. 4,956,966, a conventional draper cutting system is known, in which the cut harvested crop is conveyed by the lateral belt conveyor systems to the central belt conveyor system and by the latter into the receiving area of a slope conveyor of a combine harvester. In order to support the transfer of the material from the central belt conveyor system to the slope conveyor, U.S. Pat. No. 4,956,966 provides a feed roller in the area of the discharge opening, which features spiral sheets that move the harvested crop into the slope conveyor by way of a rotational movement the feed roller.

In such draper cutting systems, when the harvested crop has a high straw component, as in the case of canola, for instance, harvested crop may accumulate near the rear wall such that it is not removed by the belt conveyor systems, as a result of which it becomes compacted into packets that can only be removed manually during an interruption of the harvesting process.

From the introductory description of document EP 2 520 154 A1, it is known that for a cutting system with a rigid single-piece frame, a generic draper cutting system can be fitted with a screw conveyor arranged above the belt conveyor systems. There, however, such a screw conveyor is described as disadvantageous. Instead, it is suggested that press rollers with a smooth peripheral surface be used, arranged above the lateral belt conveyor systems and extending longitudinally along them.

The object of the present invention is to create a device in which an accumulation of harvested crop material near the rear wall of the lateral belt conveyor systems is prevented.

### SUMMARY OF THE INVENTION

This object is solved for a generic cutting system by the arrangement a three-part screw conveyor near the rear wall, extending across the operating width of the cutting system and located above the central and the lateral belt conveyor systems and between reel and the rear wall, such that the length of the respective parts of the screw conveyor corresponds at least approximately to the width of the frame parts, the screw conveyor parts are powered by a joint drive, and adjacent parts of the screw conveyor are mutually connected by way of universal joints.

The tripartite execution of the screw conveyor causes an unambiguous spatial alignment of the individual parts of the screw conveyor to their respective frame part and to the respective part of the rear wall, which remains identical even in case of swinging movements. This is functionally significant because as a result, even in case of swinging movements of the frame parts with respect to each other, this does not lead to variable gaps between the envelope circle of the respective screw conveyor segment and the respective part of the rear wall, in which harvested crop material might accumulate and become compacted into packets. For a frame part, the spatial alignment of the respective part of the screw conveyor remains at least approximately the same in case of swinging movements of the frame parts. Because the length of the respective parts of the screw conveyor corresponds at least approximately to the width of the frame parts, even swinging movements of the frame parts with respect to each other, depending on the swivel position, have no or only small differences in length, which can be compensated for via respective bearings in a simple and cost-effective manner.

When the reel is constructed out of three parts as well, and the widths of the reel parts correspond at least approximately to the widths of the respective frame parts and to the length of the respective parts of the screw conveyor, this also leads to an unvarying identical spatial alignment of the screw conveyor to the reel. The screw conveyor can scrape any harvested crop that remained stuck on the reel by means of the rotational movement of the spiral sheets arranged on it. As a result, the winding of the harvested crop onto the reel and the undesired conveyance thereof back to the front, where it might interfere with the reception of the material and its deposit on the belt conveyor systems can be avoided. When the screw conveyor and the reel maintain a defined spatial alignment even in case of swinging movements of the frame parts with respect to each other, the envelope circles of the reel and of the screw conveyor can be executed so close to one another that a particularly effective scraping effect is achieved.

According to one embodiment of the invention, the central part of the screw conveyor is solidly connected with the central frame part. Due to the fixed connection of the central part of the screw conveyor with the central frame part, a fixed reference value in the event of swinging frame parts follows for the lateral screw conveyor segment as well. Relative movements resulting from swinging movements of the external frame parts can be absorbed and compensated for by the external screw conveyor segments.

According to one embodiment of the invention, the lateral parts of the screw conveyor are connected at one point with the corresponding lateral frame part. The pointed connection of the respective part of the screw conveyor and the corresponding frame part leads to a number of constructional and functional advantages. The pointed connection allows for a degree of relative mobility of the screw conveyor segment with respect to the respective frame part, that is restricted without the pointed connection, specifically when the pointed connection is at an end of the screw conveyor and the other end is to be spatially repositionable. This still leads to a sufficiently accurate spatial alignment with the rear wall and with the reel.

According to one embodiment of the invention, the lateral parts of the screw conveyor are connected in a slide bearing as a connection point at their external ends with the respectively associated frame part, the slide bearing being designed such that it also allows for a rotational movement of the respective screw conveyor segment and the ends of the lateral parts of the screw conveyor that face the central frame part being in a torque-proof connection with the central part of the screw conveyor. The slide bearings allow for a lateral movement along the longitudinal axis of the screw conveyor, which may result from the swinging movement of the frame parts with respect to each other. At the same time, the pointed connection as slide bearings also allow for a rotational movement of the screw conveyor. Due to the torque-proof connection of the opposing end of the lateral screw conveyor segment with the central screw conveyor segment, drive forces are can be easily transmitted. In combination with the universal joints, this leads to a flexible drive train which does not restrict the mobility of the frame parts with respect to each other in any way, even when the universal joints are at a distance from the rotary axes around which the swinging motion of the frame parts takes place.

According to one embodiment of the invention, scrapers are arranged on the respective frame part, which are aligned toward the envelope circle of the spiral sheets of the screw conveyor segment. Scrapers can only scrape harvested crop material from a rotating component safely when the scraper has direct contact with the surface that it is meant to scrape, or at least is only a very small distance away from it, a few millimeters at the most. When the respective part of the screw conveyor and the respective scrapers are both solidly connected with the respective frame part, this results in a scraping effect that is independent of swinging movements of the frame parts relative to each other and that is reliable during any harvesting conditions.

According to one embodiment of the invention, the drive of the screw conveyor powers the central part of the screw conveyor. In case of a drive operating on the central part of the screw conveyor, the respective drive components can be arranged adjacent to the slope conveyor of the combine harvester. As a result, the weight of the drive will be located approximately in the middle of the machine. Other than in case of a drive via the outer sides of the cutting system, the weight and leverage forces operating on the frame are smaller here, and the drive forces do not have to be guided outward. The outer sides of the cutting system can be executed in a more streamlined manner when no additional drive components are mounted there. The central drive allows for moving the spiral sheets of the screw conveyor all the way to the external side parts of the cutting system. This way, dead areas in the external area of the cutting system in which the screw conveyor is prevented by drive components from performing its task over the full operating width of the cutting system, can be avoided.

The drive may be executed as a hydraulic or as a mechanical drive. For a hydraulic drive, the connecting valves for the work hydraulics of the combine harvester are arranged on the slope conveyor in close proximity, such that only short connections are necessary. A mechanical output could also be diverted with a low structural use of draper input gears that are also arranged nearby. The interfaces for hydraulic and mechanical drives are located at the slope conveyor, such that for the transfer of the drive force, from the interfaces to the central part of the screw conveyor, only short distances have to be bridged. When the central part of the screw conveyor is in a stationary connection with the central frame part of the cutting system, the ways for transferring the drive force are not variable when the central frame part is also in a stationary connection with the slope conveyor of the combine harvester. The mobility of the frame parts relative to each other has no impact on the drive train to the central part of the screw conveyor.

According to one embodiment of the invention, the screw conveyor segments are attached to their respective frame part or to the respective rear wall. In particular when the supporting elements that support the cutter bar and/or the guide and drive elements of the belt conveyor systems are movable relative to the frame and/or the rear wall, attachment of the screw conveyor segment to the frame or to the rear wall prevents the screw conveyor segment from participating in the movements of such supporting elements. As a result, the drive of the screw conveyor can be simplified, and the function is more reliable, independently of the swinging of the supporting elements and of the frame parts with respect to each other.

According to one embodiment of the invention, the spiral sheets on one section of the central screw conveyor segment feature a stronger gradient than spiral sheets on a section of the lateral screw conveyor segment. The stronger gradient of the spiral sheets on the central screw conveyor segment effectuates a faster discharge of the harvested crop transported by the screw conveyor. The faster discharge improves the reception of the harvested crop transported by the lateral screw conveyor segments to the central screw conveyor segment.

According to one embodiment of the invention, a cone covering the universal joints is positioned on the screw conveyor in the area of the universal joints. The cone improves the material flow in the area of the transition from the lateral screw conveyor segment to the central screw conveyor segment. Due to the cone form that widens in the direction of the transportation of the harvested crop, the harvested crop is also transported around the drive elements and the mounting brackets of the screw conveyor.

According to one embodiment of the invention, the screw conveyor segments are mutually connected in a torque-proof connection in the connection area by way of shaft stubs that are mutually interconnected via a universal joint. The shaft stubs may be embodied as slider pins, each of which slides on a respective profile shaft. Alternatively, a shaft stub may be in a torque-proof connection with a screw conveyor segment, for instance by being solidly welded, and the other shaft stub may be slid onto a profile shaft. The shaft stubs, or respectively, the slider pins, allow for an easier assembly and disassembly of the screw conveyor. In order to assemble the central screw conveyor segment, it is aligned with the bearings connected with the central frame part. The slider pins can then be slid from the side through the bearings into the profile shaft of the central screw conveyor segment. This renders the central screw conveyor segment stationary but rotatably mounted. Now, only the lateral screw conveyor segments with their respective profile shaft must be slid onto the free slider pins and placed with their other end into the respective slide bearing at the external edge of the cutting system, and be attached. Disassembly is done in the opposite direction. The divided construction and the easy mounting and connection allow for a rapid and easy assembly and disassembly of a screw conveyor by 2 persons without a need for a further lifting device.

Additional characteristics of the invention follow from the claims, the figures, and the description of the figures. All the characteristics and combinations of characteristics mentioned in the description above, as well as the characteristics and combinations of characteristics mentioned in the description of the figures and/or merely shown in the figures, can be used not only in the respective specified combination, but also in other combinations or on their own.

### BRIEF DESCRIPTION OF THE DRAWINGS

The invention will be further explained based on a preferred exemplary embodiment and with reference to the enclosed drawings.

The figures show as follows:

FIG. 1: an oblique top view of a cutting system,

FIG. 2: a frontal view of a cutting system,

FIG. 3: a sectional view of a cutting system from the side,

FIG. 4: a partial view of the area of the drive of the screw conveyor,

FIG. 5: a sectional view of the drive area shown in FIG. 4,

FIG. 6: a partial view of the area of the connection between the central screw conveyor segment to the lateral screw conveyor segment,

FIG. 7: a view of the slide bearings of a lateral screw conveyor segment, and

FIG. 8: a sectional view of a scraper.

### DESCRIPTION OF PREFERRED EMBODIMENTS

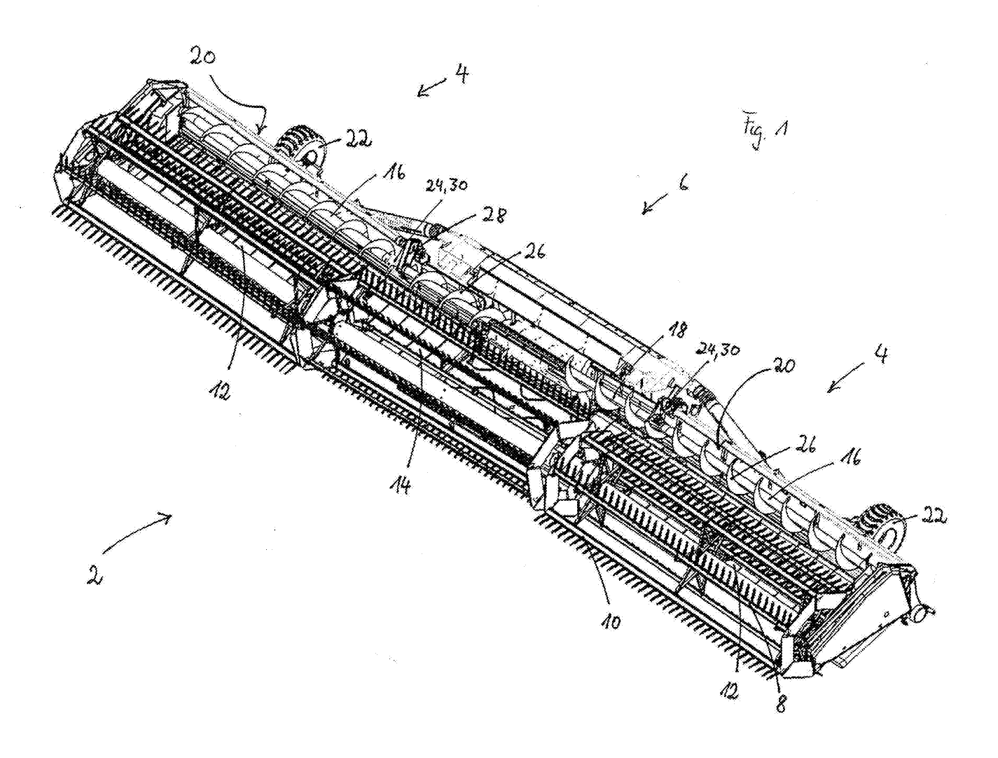

FIG. 1 shows an oblique top view of a cutting system 2. The cutting system 2 features a three-part frame consisting of two lateral frame parts 4 and a central frame part 6. At the front of the cutting system 2 when viewed in the travel direction, there is a cutter bar 10. The three-part reel 8 [shown] in the exemplary embodiment is located above the cutter bar 10. The harvested crop cut by the cutter bar 10 is discharged by the reel 8 onto the two lateral belt conveyor systems 12 and the central belt conveyor system 14. The two lateral belt conveyor systems 12 transport the harvested crop transversely to the direction of travel onto the central belt conveyor system 14, which discharges the harvested crop backward, in the direction contrary to the direction of travel, onto the slope conveyor of a combine harvester that is connected to the cutting system.

A rear wall 20 is located in the rear area of the cutting system 2, constructed on the respective frame parts 4, 6 and extending along the conveyor line of the harvested crop via the belt conveyor systems 12, 14. The rear wall 20 is closed, with the exception of a discharge opening for the delivery of the harvested crop to the combine harvester. It is exactly or approximately vertical, and it protrudes clearly above the upper surface of the belt conveyor systems 12, 14.

Near the rear wall 20, and specifically: above the central and the lateral belt conveyor systems 12, 14 and between the reel 8 and the rear wall 20, a screw conveyor is located, consisting of two lateral screw conveyor segments 16 and a central screw conveyor segment 18. The screw conveyor segments 16, 18 feature spiral sheets 26, by way of which straw can be transported transversely towards the discharge opening following a rotation of the screw conveyor.

The lateral frame parts 4 are supported on the ground by way of support wheels 22. Since the central frame part 6 is supported by the slope conveyor of the combine harvester since its working height can be adjusted by adjusting the height of the slope conveyor, the lateral frame parts 4 can swing upward or downward, depending on the ground contours, via a respective articulated connection with the central frame part 6 around the pivoting axis which extends in the travel direction. The height alignment is controlled via the support wheels 22 which follow the ground contours. The support wheels 22 may be height-adjustable.

Due to the capacity of the lateral frame parts 4 to swivel relative to the central frame part 6, it is necessary that when swinging movements of the lateral frame parts 4 occur, the screw conveyor can reproduce the respective movements of the lateral frame parts 4. Due to the tripartite division of the screw conveyor into two lateral screw conveyor segments 14 and a central screw conveyor segment 18, universal joints 24 may be arranged in the partition area, which connect the lateral screw conveyor segments 16 with the central screw conveyor segment 18 in a torque-proof connection, and transfer a drive force to the rotating screw conveyor segment 16, 18. The universal joints 24 arranged in the partition area allow for the pivoting of the individual screw conveyor segments 16, 18 together with the respective frame parts 4, 6.

In the exemplary embodiment, the screw conveyor segments 16, 18 are adjusted in terms of their length to the operating width of the frame parts 4, 6. During swinging movements of the lateral frame parts 4 relative to the central frame part 6, as a result, overlaps are avoided, which are constructively difficult to control due to the different swing radii.

In the exemplary embodiment, the screw conveyor is driven by the central screw conveyor segment 18. For these purposes, a drive 28 is arranged on the central frame part 6, which transfers a drive force from a hydraulic motor via a gear step to the central screw conveyor segment 18.

In FIG. 1, the universal joints 24 are respectively covered by a cone 30. The cone 30 protects the universal joints against contamination and supports the transportation of the harvested crop from a lateral screw conveyor segment 16 to the central screw conveyor segment 18.

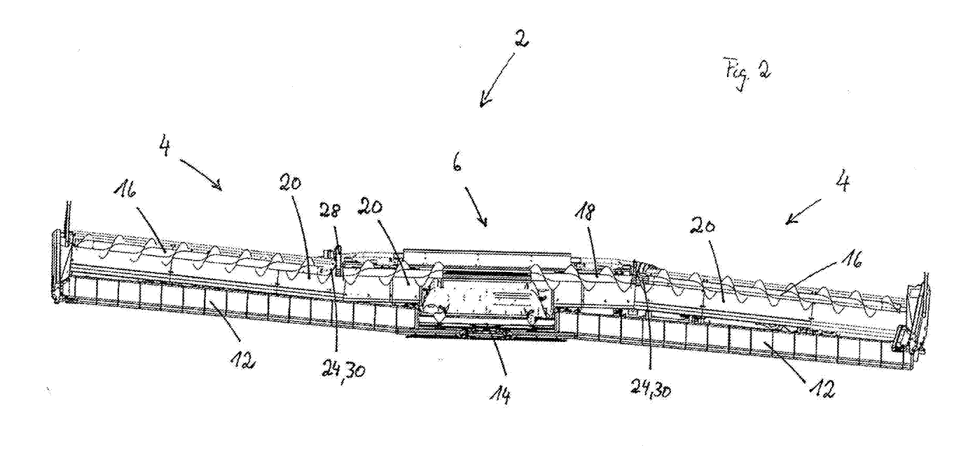

FIG. 2 shows a front view of a cutting system 2. In this view, the reel 8 was omitted. In the view in FIG. 2, it can be seen that the lateral frame parts 4 are swiveled relative to the central frame part 6. From the front view, one can see that the length of the screw conveyor segments 16, 18 are adjusted to the width of the respective frame parts 4, 6. The lateral belt conveyor systems 12 and the central belt conveyor system 14 are clearly identifiable in this view as well. The three-part rear wall 20 is clearly identifiable in this view as well. The universal joints 24 with the respective cone 30 are located in the transition area between the lateral frame parts 4 to the central frame part 6. The drive 28 is clearly identifiable as well.

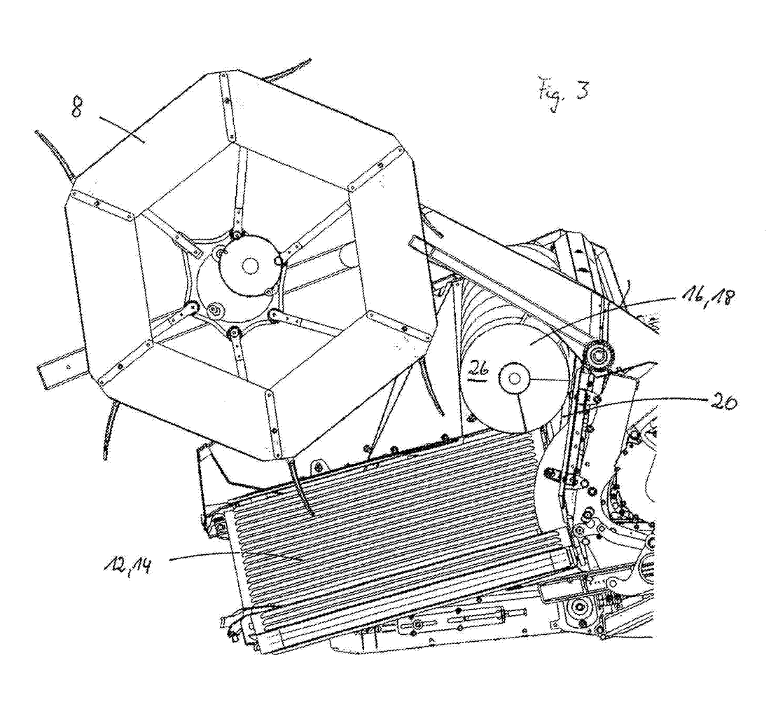

FIG. 3 shows a sectional view of a cutting system 2 from the side. In the side view, the spatial association between the reel 8, the screw conveyor segments 16, 18, the rear wall 20, and the belt conveyor systems 12, 14 are clearly identifiable. The screw conveyor segments 16, 18 are arranged near the rear wall 20 above the central and the lateral belt conveyor system 12, 14 and between the reel 8 and the rear wall 20. The screw conveyor segments 16, 18 do not leave any gap between their spiral sheets 26 and the rear wall 20. The spiral sheets 26 are also located close to the envelope circle of the tines of the reel 8, such that the spiral sheets 26 can also scrape and discharge straw parts stuck on the tines.

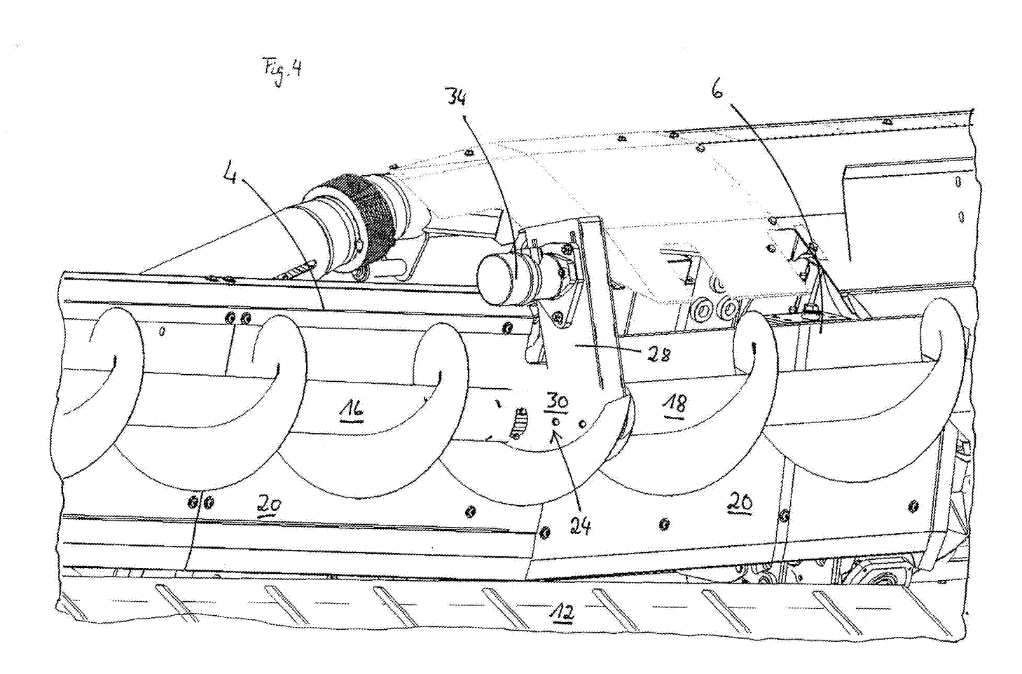

FIG. 4 shows a partial view of the area of the drive 28 of the central screw conveyor segment 18. In the exemplary embodiment, the drive 28 is powered by a hydraulic motor 34. The hydraulic motor drives the central screw conveyor segment 18. By means of a universal joint 24 covered by a cone 30, the drive force is transferred by the drive 28 from the central screw conveyor segment 18 to the lateral screw conveyor segment 16.

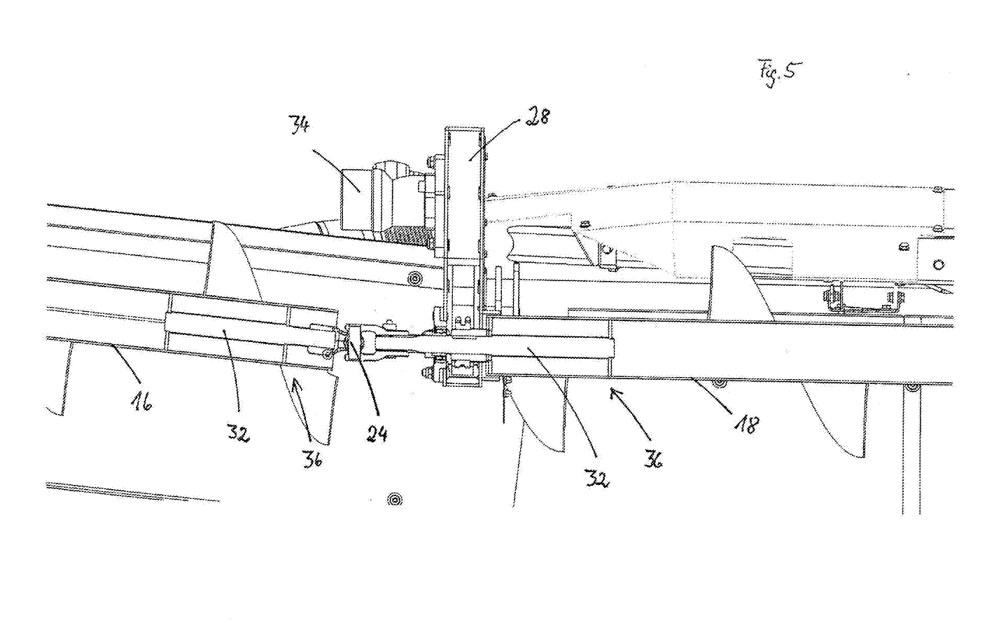

FIG. 5 shows a sectional view of the drive area shown in FIG. 4. In this sectional view, the universal joint 24 is identifiable, with two slider pins 32 extending from it, respectively forming a shaft stub. The slider pins 32 can be held in a torque-proof connection in profile shafts 36, embodied in the central and the lateral screw conveyor segments 16, 18. By way of interlocking external and internal gearing of the slider pins 32 and the profile shaft 36, these can be easily connected with each other by way of sliding, and when required for maintenance, be easily disconnected again. In the exemplary embodiment, the slider pin 32 associated with the central screw conveyor segment 16 is solidly welded as a shaft stub to the central screw conveyor segment. The central screw conveyor segment 18 can also be easily assembled with solidly welded shaft stubs and the appended universal joint 24 and slider pin 32. The drive force for driving the lateral screw conveyor segment 18 is transferred via the universal joint 24 to the lateral screw conveyor segment 16. While the central screw conveyor segment 18 is held in a stationary connection via the drive 28, the end of the lateral screw conveyor segment 16 shown in FIG. 5 is held by the slider pin 32. At this point, therefore, the lateral screw conveyor segment 16 is not connected with the respective lateral frame part 4. Rather, the connection of the lateral screw conveyor segment 16 with the respective lateral frame part 4 is accomplished at another location of the lateral frame part 4.

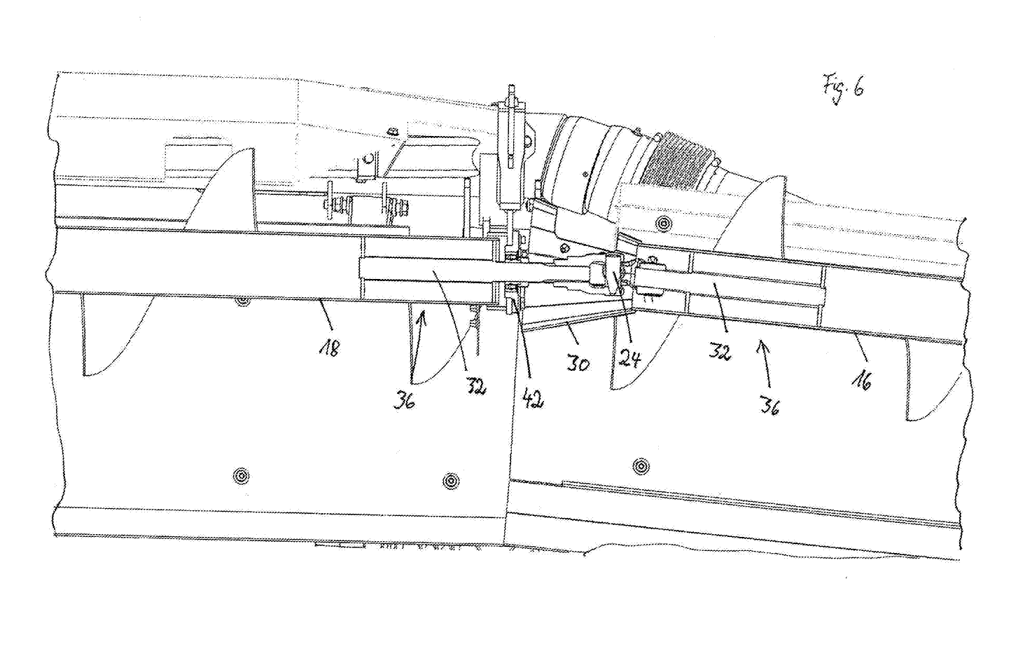

FIG. 6 shows the constructive design of the coupling of the other lateral screw conveyor segment 16 with the central screw conveyor segment 18. Since no drive 28 is provided here, a simple mounting of the central screw conveyor segment 18 via a bearing 42, into which a slider pin 32 is inserted, is sufficient. The slider pin 32 is connected here with the central screw conveyor segment 18 again via the profile shaft 36.

On the opposite side of the universal joint 24, the second slider pin 32 is located, which is inserted in the profile shaft 36 of the lateral screw conveyor segment 16. Here too, the slider pin 32 forms the mounting for an end of the lateral screw conveyor segment 16.

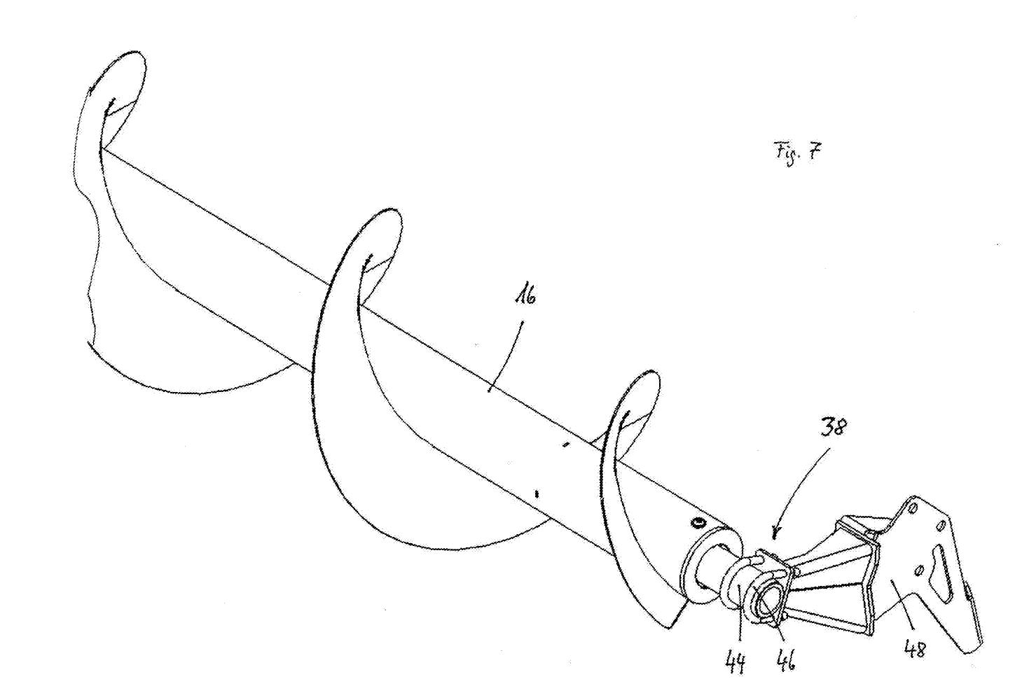

FIG. 7 shows an exemplary embodiment [which demonstrates] how the end of a lateral screw conveyor segment 16 that points away from the central frame part 6 can be supported by a slide bearing 38. In the exemplary embodiment, the shaft stub 44 is arranged in a plastic bushing supported by two support lugs 46. The plastic bushing allows for an axial movement of the shaft stub 44 as well as for a rotational movement of the shaft stubs 44 in the plastic bushing connected with the support lugs 46. The support lugs 46 are arranged on a console 48 which is solidly connected with the rear wall 20 or with the lateral frame part 4.

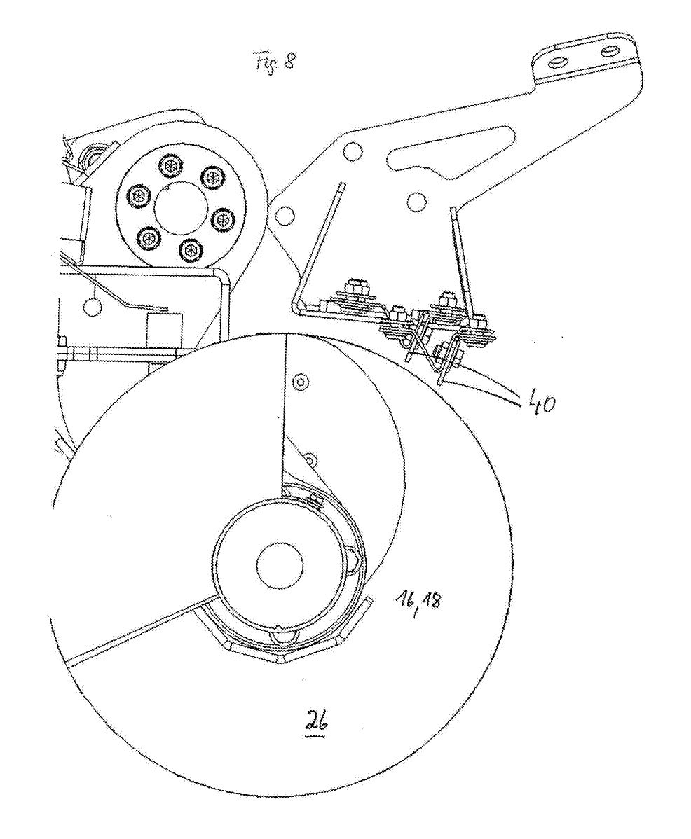

FIG. 8 shows a sectional view of a scraper 40. The two scrapers 40 are arranged such that they are in the immediate proximity of the envelope circle of the spiral sheets 26.

The invention is not limited to the aforementioned exemplary embodiment. The person skilled in the art has no difficulty modifying the exemplary embodiment in a manner he deems suitable for the purposes of a concrete application.

What is claimed is:

1. A cutting system (2), to be attached to a combine harvester with a three-part frame, of which the frame parts (4, 6) are articulately joined with each other, a cutter bar (10), a reel (8), a central belt conveyor system (14), and a lateral belt conveyor systems (12) for discharging the cut stalk material, supported by a frame (4, 6), such that the lateral belt conveyor systems (12) move transversely to the direction of travel towards the central belt conveyor system (14), and the central belt conveyor system (14) moves contrary to the direction of travel, furthermore, a multi-part rear wall (20) of the cutting system (2), embodied to the frame parts (4, 6) of the frame, which extends along the conveyor line of the lateral belt conveyor systems (12), and which features a discharge opening in the area of the central belt conveyor system (14) for the delivery of the harvested crop to the combine harvester, as well as drive units for driving the cutter bar (10), the reel (8), and the belt conveyor systems (12, 14), characterized in that near the rear wall, a three-part screw conveyor is arranged, which extends across the operating width of the cutting system (2) and is arranged above the central and the lateral belt conveyor systems (12, 14) and between the reel (8) and the rear wall (20), such that the length of the respective parts (16, 18) of the screw conveyor correspond at least approximately to the width of the frame parts (6, 8), the screw conveyor parts (16, 18) are powered by a joint drive, and adjacent parts (16, 18) of the screw conveyor are mutually connected by way of universal joints (24).

2. The cutting system (2) according to claim 1, wherein the central part (18) of the screw conveyor is solidly connected with the central frame part (6).

3. The cutting system (2) according to claim 1, wherein the lateral parts (16) of the screw conveyor are connected at one point with the respectively associated frame part (4, 6).

4. The cutting system (2) according to claim 3, wherein the lateral parts (16) of the screw conveyor are connected with their external ends in a slide bearing (38) as a connection point with the respectively associated frame part (4, 6), the slide bearing (38) being designed such that it also allows for a rotational movement of the respective screw conveyor segment (16, 18) and the ends of the lateral parts (16) of the screw conveyor that face the central frame part (6) being in a torque-proof connection with the central part (18) of the screw conveyor.

5. The cutting system (2) according to claim 1, wherein scrapers (40) aligned toward the envelope circle of the spiral sheets (26) of the screw conveyor segment (16, 18) are arranged on the respective frame part (4, 6).

6. The cutting system (2) according to claim 1, wherein the drive (28) of the screw conveyor powers the central part (18) of the screw conveyor.

7. The cutting system (2) according to claim 1, wherein the screw conveyor segments (16, 18) are connected to their respective frame part (4, 6) or to the respective rear wall (20).

8. The cutting system (2) according to claim 1, wherein spiral sheets have a stronger gradient in one section of the central screw conveyor segment (18) than spiral sheets on a section of the lateral screw conveyor segment.

9. The cutting system (2) according to claim 1, wherein in the area of universal joints (24), a cone (30) covering the universal joints (24) is positioned on the screw conveyor.

10. The cutting system (2) according to claim 1, wherein the screw conveyor segments (16, 18) are connected with each other in the connection area in a torque-proof connection by way of shaft stubs that are mutually connected via a universal joint (24).
